(19) United States
(12) Patent Application Publication
(10) Pub. No.: US 2023/0376703 A1
(43) Pub. Date: Nov. 23, 2023

(54) MULTIPLE IDENTIFIERS OF RADIO FREQUENCY IDENTIFICATION (RFID) TAGS

(71) Applicant: HEWLETT-PACKARD DEVELOPMENT COMPANY, L.P., Spring, TX (US)

(72) Inventors: Jefferson P. WARD, Vancouver, WA (US); Stephen D. PANSHIN, Corvallis, OR (US); Marina FERRAN FARRES, Vancouver, WA (US)

(21) Appl. No.: 17/751,237

(22) Filed: May 23, 2022

(51) Int. Cl. G06K 7/10; G06K 7/00; G06K 19/07

(52) U.S. Cl. CPC G06K 7/10108; G06K 7/0008; G06K 19/0723

(57) ABSTRACT

In some examples, an electronic device includes a network interface and a controller. The controller receives, via the network interface, an identifier of a radio frequency identification (RFID) tag, and generates a notification in response to the identifier being different from a set of identifiers stored to a storage device. The set of identifiers includes multiple identifiers associated with the RFID tag.

### BACKGROUND

Radio frequency identification (RFID) systems include RFID tags, RFID readers, and electronic devices that enable access to data structures storing data associated with the RFID tags. An RFID tag includes a unique identifier (ID) that is used to track a tangible object with which the RFID tag is associated.

### BRIEF DESCRIPTION OF THE DRAWINGS

Various examples are described below referring to the following figures.

FIG. 1 is a block diagram of a system for verifying identifiers of RFID tags, in accordance with various examples.

FIG. 2 is a flow diagram of a method for provisioning an RFID tag with multiple identifiers, in accordance with various examples.

FIG. 3 is a flow diagram of a method for provisioning an RFID tag with multiple identifiers, in accordance with various examples.

FIG. 4 is a block diagram of an electronic device for transmission of identifiers for verification, in accordance with various examples.

FIG. 5 is a block diagram of an electronic device for verifying identifiers of RFID tags, in accordance with various examples.

FIG. 6 is a flow diagram of a method for verifying and provisioning identifiers of RFID tags, in accordance with various examples.

FIG. 7 is a flow diagram of a method for verifying and provisioning identifiers of RFID tags, in accordance with various examples.

FIG. 8 is a flow diagram of a method for verifying and provisioning identifiers of RFID tags, in accordance with various examples.

FIG. 9 is an electronic device for verifying identifiers of RFID tags, in accordance with various examples.

### DETAILED DESCRIPTION

As described above, an RFID system tracks a tangible object that includes an RFID tag. The tangible object is an identification card for a person to gain entrance into a secure building, a good within a supply chain, a piece of inventory, or other suitable object for tracking, for instance. The RFID reader interrogates the RFID tag by transmitting a radio frequency (RF) signal. In response to the RFID tag detecting the RF signal, the RFID tag transmits another RF signal that includes the ID associated with the RFID tag. Using an unauthorized RFID scanner, malicious third parties intercept the RF signal that includes the ID from the RFID tag. The malicious third parties use the RFID tag in unauthorized manners. For instance, a malicious third party generates an RFID tag to impersonate the object or tracks the object for an opportune moment to steal the object.

This description describes an RFID system that utilizes an RFID tag having a set of IDs associated with the RFID tag. The set of IDs are globally unique identifiers (GUIDs) of a specified length. GUIDs may also be referred to as universally unique identifiers (UUIDs). The specified length is 16 bytes, for example. In response to subsequent interrogations from RFID readers, the RFID tag responds with a different ID of the set of IDs. For example, in response to a first interrogation, the RFID tag responds with a first ID, and in response to a second interrogation, the RFID tag responds with a second ID that is different from the first ID. The electronic device receives the ID and compares the ID to data of a data structure that includes the set of IDs for the RFID tag. In various examples, in response to the ID not being equivalent to an expected ID of the set of IDs, the electronic device flags the RFID tag as compromised, blocks recognition of remaining IDs of the set of IDs, or a combination thereof.

In some examples, in response to the ID not being equivalent to any ID of the set of IDs for the RFID tag, the electronic device generates a notification. In other examples, in response to the ID not being equivalent to an expected ID of the set of IDs, where the expected ID is based on a number of interrogations of the RFID tag, the electronic device generates the notification. The notification includes information that the RFID tag has been compromised, that the remaining IDs of the set of IDs have been blocked, that the ID is not equivalent to any ID of the set of IDs for the RFID tag, that a failure has occurred in reading the ID, or a combination thereof. In various examples, in response to a determination that a last ID of the set of IDs has been utilized, a secure connection is established between the RFID tag and the electronic device to replace the set of IDs stored to the RFID tag with a second set of IDs.

Utilizing the RFID tag having the set of IDs blocks malicious third parties from using an intercepted ID because the electronic device would recognize subsequent attempts to use the intercepted ID as a fraudulent access. Enabling the electronic device to update the RFID tag with a second set of IDs enhances a security of the RFID tag by provisioning the RFID tag with changing identifiers that block malicious parties from duplicating verifiable identifiers. Having IDs that are a specified length reduces a likelihood of two objects having a same ID and of a malicious third party determining the ID.

In some examples in accordance with the present description, an electronic device is provided. The electronic device includes a network interface and a controller. The controller receives, via the network interface, an identifier of a radio frequency identification (RFID) tag, and generates a notification in response to the identifier being different from a set of identifiers stored to a storage device. The set of identifiers includes multiple identifiers associated with the RFID tag.

In some examples in accordance with the present description, an electronic device is provided. The electronic device includes an antenna, a storage device to store multiple identifiers associated with the electronic device, and a controller. In response to receiving a first radio frequency (RF) signal requesting identification of the electronic device at a first time, the controller transmits, via the antenna, a first identifier of the multiple identifiers. In response to receiving a second RF signal requesting the identification at a second time subsequent to the first time, the controller transmits, via the antenna, a second identifier of the multiple identifiers, the second identifier different from the first identifier.

In some examples in accordance with the present description, a non-transitory machine-readable medium storing machine-readable instructions is provided. The term “non-transitory,” as used herein, does not encompass transitory propagating signals. The machine-readable instructions, when executed by a controller of an electronic device, cause the controller to receive data of a radio frequency identification (RFID) tag. The data includes an identifier, a counter value, or a combination thereof. The machine-readable instructions, when executed by the controller, cause the controller to determine whether an unauthorized access of the RFID tag has occurred based on the identifier being different from multiple identifiers associated with the RFID tag. In response to a determination that the data indicates an occurrence of the unauthorized access, the machine-readable instructions, when executed by the controller, cause the controller to generate a notification.

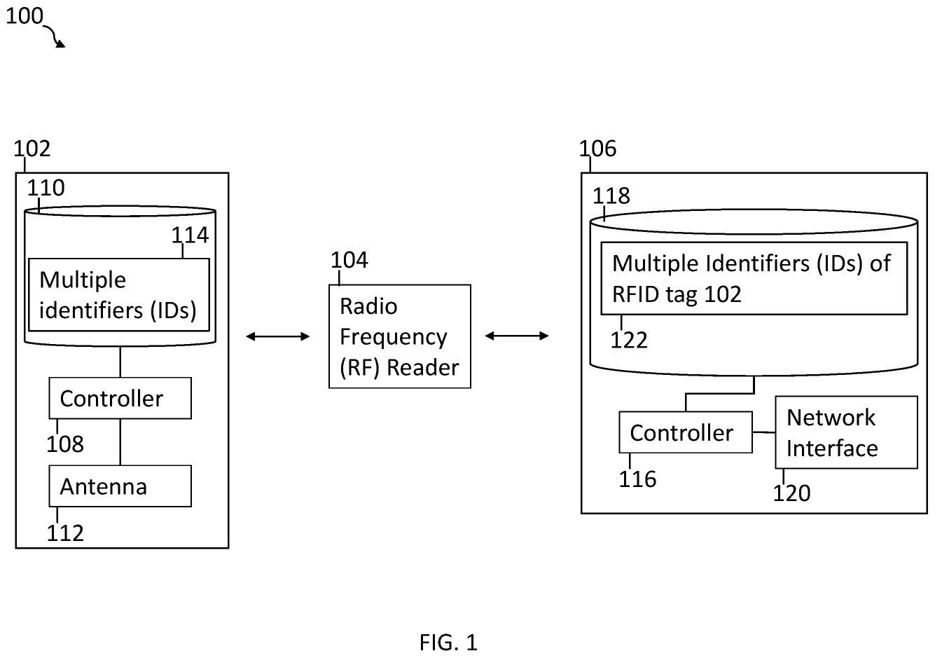

Referring now to FIG. 1, a block diagram of a system 100 for verifying identifiers of RFID tags is shown, in accordance with various examples. The system 100 includes an RFID tag 102, an RFID reader 104, and an electronic device 106. The RFID tag 102 is an electronic device that is affixed to a surface of a tangible object, disposed within the tangible object, affixed to a surface of a package for the tangible object, or physically connected to (e.g., associated with) the tangible object in some other suitable manner. The RFID reader 104 is any suitable electronic device that is able to propagate an RF signal, detect a return RF signal, and transmit data of the return signal to the electronic device 106. The RFID reader 104 is an RFID scanner, a smartphone, or a tablet, for example. The electronic device 106 is a desktop, laptop, notebook, tablet, smartphone, or other suitable computing device able to verify identifiers of the RFID tag 102.

In various examples, the RFID tag 102 includes a controller 108, a storage device 110, and an antenna 112. The controller 108 is coupled to the storage device 110 and the antenna 112, for example. The controller 108 is a microcontroller, a microcomputer, a programmable integrated circuit, a programmable gate array, or other suitable device for managing operations of the RFID tag 102. The storage device 110 is a hard drive, a solid-state drive (SSD), flash memory, random access memory (RAM), a one-time programmable memory (e.g., an electronic fuse), or other suitable memory for storing data or machine-readable instructions of the RFID tag 102. The storage device 110 stores multiple identifiers 114 (IDs 114). The antenna 112 is any suitable antenna for a type of the RFID tag 102. The type of the RFID tag 102 is a low-frequency type, a high-frequency type, or an ultra-high-frequency type, for example. The low-frequency type, as used herein, indicates a frequency range of the RFID tag 102 is 30 to 300 kilohertz (kHz). The high-frequency type, as used herein, indicates a frequency range of the RFID tag 102 is 3 to 30 Megahertz (MHz). The ultra-high-frequency type, as used herein, indicates a frequency range of the RFID tag 102 is 300 MHz to 3 gigahertz (GHz). The antenna 112 is a coil of wire or a dipole antenna, for example.

While in some examples, the RFID tag 102 is shown as a passive RFID tag, in other examples, the RFID tag 102 includes other components. For example, the RFID tag 102 is an active RFID tag, includes a battery, and periodically transmits signals for tracking. In another example, the RFID tag 102 is a semi-passive RFID tag (e.g., battery-assisted RFID tag) and includes a battery that is used once a signal is received by the RFID tag 102. A passive RFID tag, as used herein, is dormant until the RFID tag 102 receives a signal.

In various examples, the electronic device 106 includes a controller 116, a storage device 118, and a network interface 120. The controller 116 is coupled to the storage device 118 and the network interface 120. The controller 116 is a microcontroller, a microcomputer, a programmable integrated circuit, a programmable gate array, or other suitable device for managing operations of the electronic device 106. For example, the controller 116 is a central processing unit (CPU), a graphics processing unit (GPU), or an embedded security controller (EpSC). The storage device 118 is a hard drive, a solid-state drive (SSD), flash memory, random access memory (RAM), or other suitable memory for storing data or machine-readable instructions of the electronic device 106. The storage device 118 stores multiple identifiers 122 (IDs 122) of the RFID tag 102 and other RFID tags of the system 100. The network interface 120 enables communication over a network. The network interface 120 may include a wired (e.g., Ethernet, Universal Serial Bus (USB)) or a wireless (e.g., WI-FI®, BLUETOOTH®) connection. The network is a local area network (LAN), a wide area network (WAN), a virtual private network (VPN), a client/server network, an Internet (e.g., cloud), or any other suitable system for sharing data between different electronic devices. The network interface 120 enables communication between the RFID tag 102, the RFID reader 104, and the electronic device 106, for example.

While in some examples, the electronic device 106 is an integrated electronic device, in other examples, the controller 116 is a controller of a first electronic device that is communicatively coupled, via the network interface 120, to a second electronic device that includes the storage device 118. The storage device 118 is an enterprise cloud, a public cloud, a data center, a server, or some other suitable remotely managed storage device, for example. The storage device 118 is remotely managed by the controller 116, for example.

As described above, in various examples, the system 100 verifies IDs 114 of the RFID tag 102. The IDs 114 are GUIDs of a specified length. While in some examples, the specified length is 16 bytes, in other examples, the specified length is another suitable length that enables different RFID tags to have non-overlapping sets of IDs. In response to subsequent interrogations from the RFID reader 104, the RFID tag 102 responds with a different ID of the IDs 114. For example, in response to a first interrogation, the RFID tag 102 responds with a first ID of the IDs 114, and in response to a second interrogation, the RFID tag 102 responds with a second ID of the IDs 114 that is different from the first ID.

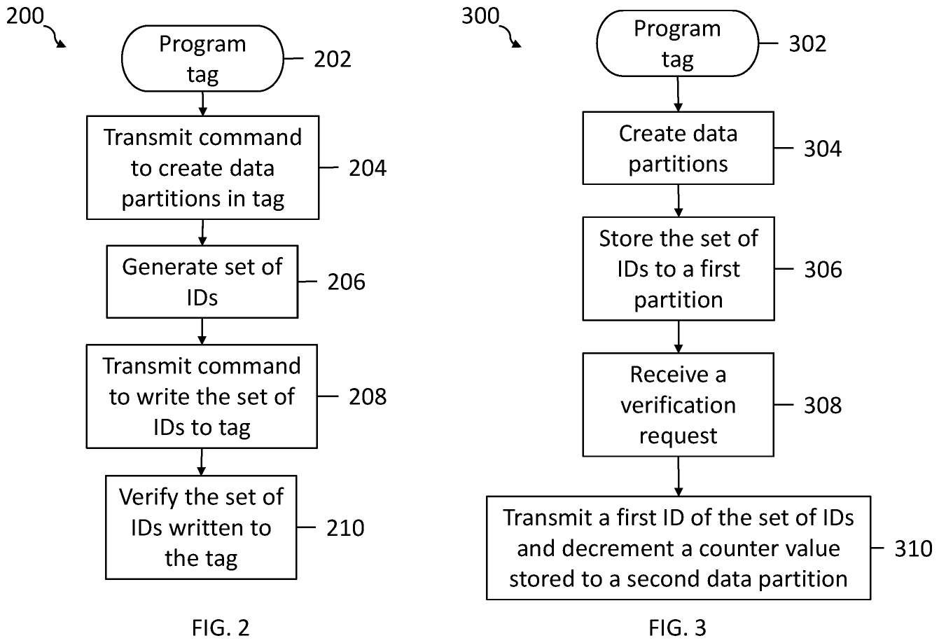

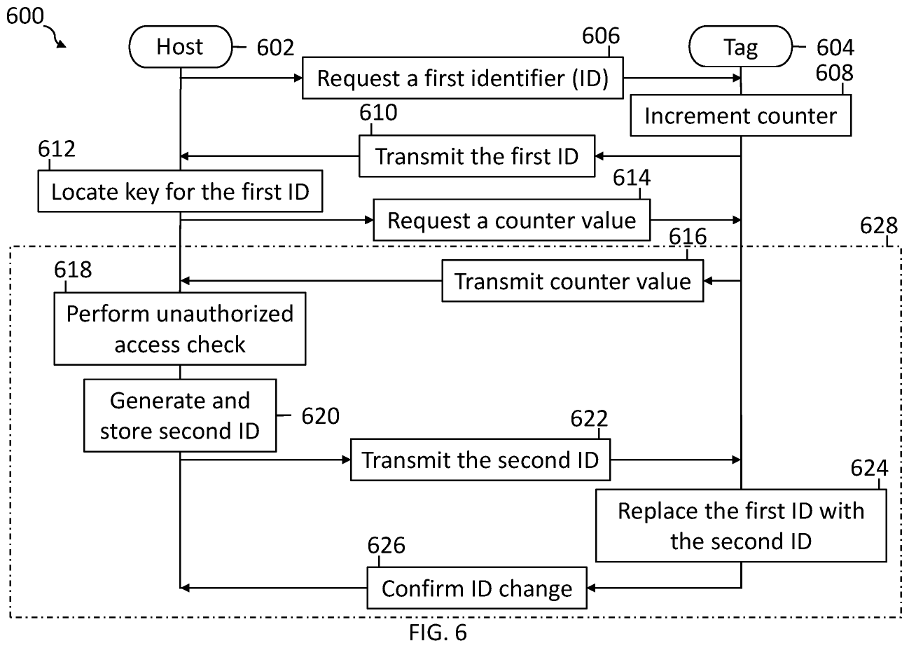

In various examples, the electronic device 106 receives an ID of the RFID tag 102 via the network interface 120. The electronic device 106 compares the ID to the IDs 122. In some examples, in response to the ID not being equivalent to any ID of the set of IDs for the RFID tag or not being equivalent to an expected ID of the set of IDs, the electronic device flags the RFID tag as compromised, blocks recognition of remaining IDs of the set of IDs, generates a notification that the ID is not equivalent to an expected ID of the set of IDs, generates a notification that the ID is not equivalent to any ID of the set of IDs for the RFID tag, generates a notification that a read error occurred or may have occurred in reading the ID, ignores detection of the ID, or a combination thereof. In some examples, in response to the ID not being equivalent to any ID of the IDs 122, the electronic device 106 generates a notification. In other examples, in response to the ID not being equivalent to an expected ID of the IDs 122, where the expected ID is based on a number of interrogations of the RFID tag 102, the electronic device 106 generates the notification. The notification includes information that the RFID tag has been compromised, that the remaining IDs of the set of IDs have been blocked, or a combination thereof. In some examples, in response to a determination that a last ID of the IDs 122 has been used, a secure connection is established between the RFID tag 102 and the electronic device 106 using the techniques described below with respect to FIG. 6. The secure connection is used to replace the IDs 114 stored to the RFID tag 102 with a second set of IDs generated by the electronic device 106 and stored to the storage device 118. The electronic device 106 replaces the IDs 114 of the RFID tag 102 using the techniques described below with respect to FIG. 2, for example. The RFID tag 102 stores the second set of IDs using the techniques described below with respect to FIG. 3, for example.

In some examples, the electronic device 106 receives an ID via the network interface 120. In response to a determination that neither the IDs 122 nor the IDs of other RFID tags include the ID, the electronic device 106 generates the notification. In other examples, in response to the ID not being equivalent to an expected ID of the IDs of the other RFID tags, where the expected ID is based on a number of interrogations of the RFID tag 102, the electronic device 106 generates the notification.

Referring now to FIG. 2, a flow diagram of a method 200 for provisioning an RFID tag (e.g., the RFID tag 102) with multiple identifiers (e.g., the IDs 114) is shown, in accordance with various examples. The method 200 includes a start point that indicates to program the RFID tag at step 202. The method 200 also includes transmitting a command to create data partitions in the RFID tag at step 204. Additionally, the method 200 includes generating a set of IDs at step 206. The method 200 includes transmitting a command to write the set of IDs to the RFID tag at step 208. The method 200 also includes verifying the set of IDs is written to the RFID tag at step 210.

In various examples, transmitting the command to create data partitions in the RFID tag includes transmitting a signal, or multiple signals, in accordance with a standard or specification that governs operations of the RFID tag. For example, a first type of storage device (e.g., the storage device 110) of the RFID tag creates the data partitions in response to receiving a first signal while a second type of storage device creates the data partitions in response to receiving a second signal, where the second signal is different from the first signal. In another example, a third type of storage device of the RFID tag creates the data partitions in response to receiving a series of signals.

Generating the set of IDs, in some examples, includes generating the set of IDs in accordance with a standard or specification that governs generation of unique IDs. The standard or specification is in compliance with the Distributed Computing Environment (DCE) as International Organization for Standardization (ISO)/International Electrotechnical Commission (ISO/IEC) 11578:1996, ISO/IEC 9834-8:2005, or other suitable standard that includes descriptions for generating unique identifiers, for example. The standard or specification is to generate GUIDs, for example. In some examples, the specified length is determined by the standard or specification that governs generation of the unique IDs. In other examples, the specified length is determined by a specification or standard that governs the RFID system (e.g., the system 100). The specification or standard that governs the RFID system is in compliance with guidelines of the ISO, the Electronics Product Code Global Incorporated (EPCglobal), or other suitable governing entity. In various examples, the set of IDs are stored to a storage device (e.g., the storage device 118) of the electronic device (e.g., the electronic device 106) performing the method 200 or to a storage device of the RFID system.

In some examples, verifying the set of IDs is written to the RFID tag includes transmitting a request for an identifier. In response to receiving the identifier, verifying the set of IDs includes comparing the identifier to a first identifier of the set of IDs stored to the storage device of the electronic device performing the method 200 or to the storage device of the RFID system. In response to the comparison indicating that the identifier is equivalent to the first identifier, the method 200 includes generating a notification that indicates successful programming of the RFID tag. In response to the comparison indicating that the identifier is not equivalent to the first identifier, the method 200 includes generating a notification that indicates unsuccessful programming of the RFID tag.

In other examples, verifying that the set of IDs is written to the RFID tag includes transmitting a request for a first identifier and a second identifier. In response to receiving the first identifier, verifying the set of IDs includes comparing the first identifier to the first identifier of the set of IDs stored to the storage device of the electronic device performing the method 200 or to the storage device of the RFID system. In response to the comparison indicating that the first identifier is equivalent to the first identifier of the set of IDs stored to the storage device, the method 200 includes comparing the second identifier to a last identifier of the set of IDs stored to the storage device. In response to the comparison indicating that the second identifier is equivalent to the last identifier of the set of IDs stored to the storage device, the method 200 includes generating the notification that indicates successful programming of the RFID tag. In response to the comparison indicating that the second identifier is not equivalent to the last identifier of the set of IDs stored to the storage device, the method 200 includes generating the notification that indicates unsuccessful programming of the RFID tag. Other examples of verifying that the set of IDs is written to the RFID tag may be suitable such as generating a running hash value of the IDs as the set of IDs is written to the RFID tag. After completion of writing the IDs to the RFID tag the hash value may be stored and compared to a hash value computed at a contemporaneous time for IDs that are written to the RFID tag.

Referring now to FIG. 3, a flow diagram of a method 300 for provisioning an RFID tag (e.g., the RFID tag 102) with multiple identifiers (e.g., the IDs 114) is shown, in accordance with various examples. The method 300 includes a start point that indicates to program the RFID tag at step 302. The method 300 also includes creating data partitions in the RFID tag at step 304. Additionally, the method 300 includes storing a set of IDs to a first partition at step 306. The method 300 includes receiving a verification request at step 308. The method 300 also includes transmitting a first ID of the set of IDs and decrementing a counter value stored to a second data partition at step 310. In other examples, the step 310 includes a programming operation in which multiple IDs of the set of IDs are transmitted, an ID other than the first ID of the set of IDs is transmitted, a hash of an ID or IDs of the set of IDs is transmitted, or the like.

In various examples, the method 300 includes receiving a command to create data partitions in the RFID tag. The command includes a number of data partitions to create, for example. In another example, the method 300 includes receiving a second command that indicates the number of data partitions to create. In response to receiving a command to store a set of IDs, the method 300 includes storing the set of IDs to the first partition. In some examples, in response to receiving a command to store a total number of the set of IDs, the method 300 includes storing the total number of the IDs in the set of IDs to the second partition as the counter value.

In some examples, the method 300 includes receiving a command that is a request to verify the set of IDs is written to the RFID tag. In response to receiving the command, the method 300 includes transmitting a first identifier of the set of IDs. In some examples, in response to receiving the command, the method 300 also includes transmitting a last identifier of the set of IDs.

In various examples, in response to transmitting the first identifier of the set of IDs, the method 300 includes burning a bit stored to the second data partition. Burning a bit, as used herein, indicates that a value of the bit is modified from one to zero. For example, a number of bits of the second partition corresponds to the counter value. In response to the set of IDs having 32 individual IDs, for example, the second partition has 32 bits that are set to an initial value of one. To indicate that the first identifier has been transmitted, the method 300 includes modifying a bit of the 32 bits to zero. In another example, the number of bits of the second partition is equivalent to the counter value when in binary format. For example, the counter value of 32 is Ob100000, and the second partition includes 6 bits. A first bit is set to 1 and the five remaining bits are set to 0. To decrement the counter value, the method 300 includes using bitwise operations to switch the bits between 0 and 1 to indicate the decremented value. For example, to decrement Ob100000, a controller (e.g., the controller 108) switches values of the six bits such that the first bit is set to 0 and the five remaining bits are set to 1 (e.g., Ob011111).

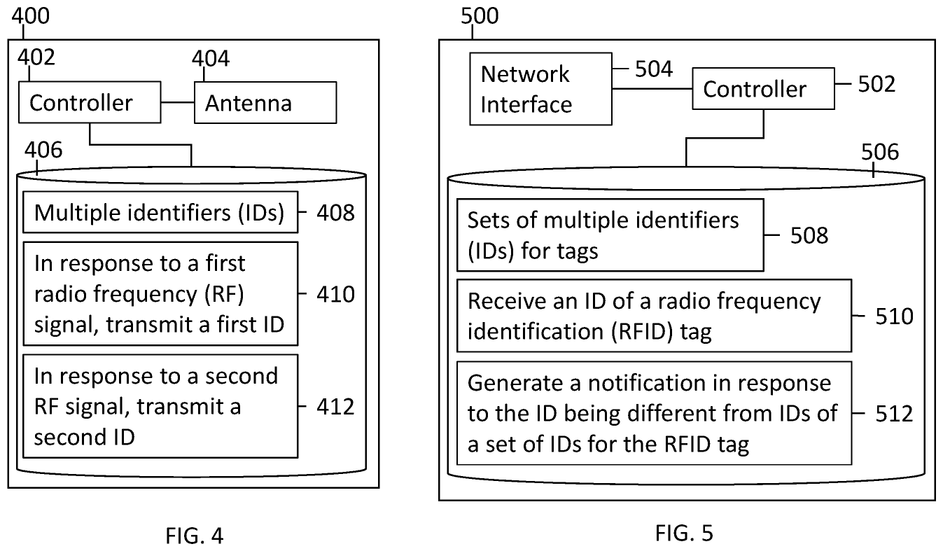

Referring now to FIG. 4, a block diagram of an electronic device 400 for transmitting an identifier of multiple identifiers 408 (IDs 408) for verification is shown, in accordance with various examples. The electronic device 400 is the RFID tag 102, for example. The electronic device 400 includes a controller 402, an antenna 404, and a storage device 406. The controller 402 is the controller 108, for example. The antenna 404 is the antenna 112, for example. The storage device 406 is the storage device 110, for example.

In some examples, the storage device 406 stores the multiple identifiers 408 and machine-readable instructions 410, 412. The machine-readable instructions 410, 412, when executed by the controller 402, cause the controller 402 to perform some or all of the actions attributed herein to the controller 402.

In various examples, the machine-readable instructions 410, 412, when executed by the controller 402, cause the controller 402 to transmit an identifier of the IDs 408, for example. In response to a first RF signal, the machine-readable instruction 410, when executed by the controller 402, causes the controller 402 to transmit a first ID. In response to a second RF signal, the machine-readable instruction 412, when executed by the controller 402, causes the controller 402 to transmit a second ID.

As described above, in some examples, the electronic device 400 includes the antenna 404, the storage device 406 to store multiple identifiers 408 associated with the electronic device 400, and the controller 402. In various examples, the first RF signal and the second RF signal include requests for an identifier. In response to receiving the first RF signal requesting identification of the electronic device 400 at a first time, the controller 402 is to transmit, via the antenna 404, a first identifier of the multiple identifiers 408. For example, the controller 402 retrieves the first identifier from the multiple identifiers 408 stored to the storage device 406 and causes the transmission, via the antenna 404, of the first identifier. In response to receiving a second RF signal requesting the identification at a second time subsequent to the first time, the controller 402 is to transmit, via the antenna 404, a second identifier of the multiple identifiers 408, where the second identifier is different from the first identifier. For example, the controller 402 retrieves the second identifier from the multiple identifiers 408 stored to the storage device 406 and causes the transmission, via the antenna 404, of the second identifier.

In various examples, in response to receiving the first RF signal requesting identification of the electronic device 400 at the first time, the controller 402 increments a counter value. The counter value is stored to the storage device 406, for example. In some examples, in response to storage of the multiple identifiers 408 to the storage device 406, the controller 402 allocates memory of the storage device 406 for the counter value and stores an initial value for the counter value. While in some examples, the initial value is 0, in other examples, the initial value is 1 or any other value specified by an RFID system (e.g., the system 100). The controller 402 transmits, via the antenna 404, the first identifier of the multiple identifiers 408 and the counter value. In some examples, in response to transmitting the first identifier, the controller 402 overwrites the first identifier of the multiple identifiers 408. The controller 402 overwrites the first identifier with a specified value that indicates the first identifier has been transmitted. The specified value is a value that indicates to an RFID reader (e.g., the RFID reader 104) or electronic device of an RFID system (e.g., the electronic device 106) that an identifier is invalid.

In other examples, in response to receiving the first RF signal requesting identification of the electronic device 400 at the first time, the controller 402 increments the counter value and transmits, via the antenna 404, the first identifier of the multiple identifiers 408 based on the counter value. For example, in response to an initial counter value of 0, the controller 402 increments the counter value by one and transmits as the first identifier an identifier of the multiple identifiers 408 that is disposed within a position indicated by the one, where the position is an address reference for a memory block storing the multiple identifiers 408. While in some examples, the multiple identifiers 408 are stored in a data structure in which a first identifier is associated with a position of zero, in other examples, the multiple identifiers 408 are stored in a data structure in which a first identifier is associated with a position of one. Data structure, as used herein, is a memory block storing data in such a way as to indicate associations between the different data. The data structure is an array, a list, or a table, for example. In some examples, an initial value of the counter value is specified by a position within the data structure of a first identifier of the multiple identifiers 408.

In some examples, the controller 402 receives, via the antenna 404, a third RF signal transmitting the second identifier at a third time. The third time is subsequent to the first time and before the second time, for example. The controller 402 stores, to the storage device 406, the second identifier. In various examples, the controller 402 replaces the first identifier with the second identifier. In other examples, the controller 402 stores the second identifier as another identifier of the multiple identifiers 408.

In various examples, the multiple identifiers 408 are a first set of identifiers. The controller 402 receives, via the antenna 404, a second set of identifiers. In some examples, the second set of identifiers includes multiple identifiers. In other examples, the second set of identifiers is a single identifier. The controller 402 stores, to the storage device 406, the second set of identifiers. In some examples, the controller 402 replaces the multiple identifiers 408 with the second set of identifiers.

Referring now to FIG. 5, a block diagram of an electronic device 500 for verifying identifiers of RFID tags is shown, in accordance with various examples. The electronic device 500 is the electronic device 106, for example. The electronic device 500 includes a controller 502, a network interface 504, and a storage device 506. The controller 502 is the controller 116, for example. The network interface 504 is the network interface 120, for example. The storage device 506 is the storage device 118, for example.

In some examples, the storage device 506 stores sets of multiple identifiers 508 for RFID tags and machine-readable instructions 510, 512. For example, the storage device 506 stores a first set of multiple identifiers for a first RFID tag, a second set of multiple identifiers for a second RFID tag, . . . and an nth set of multiple identifiers for an nth RFID tag. The machine-readable instructions 510, 512, when executed by the controller 502, cause the controller 502 to perform some or all of the actions attributed herein to the controller 502.

In various examples, the machine-readable instructions 510, 512, when executed by the controller 502, cause the controller 502 to verify an identifier of an RFID tag (e.g., the RFID tag 102, the electronic device 400), for example. The machine-readable instruction 510, when executed by the controller 502, causes the controller 502 to receive the identifier of the RFID tag. In response to the ID being different from multiple identifiers of a set of identifiers for the RFID tag, the machine-readable instruction 512, when executed by the controller 502, causes the controller 502 to generate a notification. The controller 502 transmits, via the network interface 504, the notification to a user associated with the RFID tag, for example. The user is a network administrator for an RFID system (e.g., the system 100), a customer of the RFID system, or some other entity responsible for a security of the RFID tag, for example.

In some examples, the controller 502 receives the identifier of the RFID tag. The controller 502 compares the ID to multiple identifiers of multiple sets of identifiers, where each set of the multiple sets is for a different RFID tag. In response to a determination that the identifier is not equivalent to the multiple identifiers of the multiple sets of identifiers, the controller 502 generates the notification. In various examples, the controller 502 compares the ID to a subset of the multiple sets of identifiers. The controller 502 determines the subset based on a portion of the ID, for example. The portion of the ID indicates that the ID is associated with a subset of the different RFID tags, for example.

In some examples, the controller 502 receives, via the network interface 504, a counter value of an RFID tag. The controller 502 determines whether an unauthorized access of the RFID tag has occurred based on the counter value and the identifier for the RFID tag. The controller 502 generates the notification in response to a determination that the unauthorized access has occurred. In various examples, the controller 502 generates a second identifier in response to a determination that the RFID tag is secure, for example, the RFID tag has not been subjected to unauthorized access. The controller 502 transmits, via the network interface 504, the second identifier. Prior to transmitting the second identifier, in some examples, the controller 502 establishes a secure connection with the RFID tag using the techniques described below with respect to FIG. 6.

In various examples, the controller 502 receives, via the network interface 504, a second identifier of the RFID tag. The controller 502 generates a second notification in response to the second identifier being different from the set of identifiers stored to the storage device 506. In other examples, the controller 502 receives, via the network interface 504, a second identifier of a second RFID tag. The controller 502 generates a second notification in response to the second identifier being different from a second set of identifiers stored to the storage device 506. The second set of identifiers includes multiple identifiers associated with the second RFID tag, for example.

Referring now to FIG. 6, a flow diagram of a method 600 for verifying and provisioning identifiers of RFID tags is shown, in accordance with various examples. A host 602 and an RFID tag 604 perform different portions of the method 600, for example. The host 602 is the electronic device 106, 500, for example. The RFID tag 604 is the RFID tag 102, the electronic device 400, for example. The method 600 includes the host 602 requesting a first identifier at step 606. The method 600 also includes the RFID tag 604 incrementing a counter value in response to receiving the request for the first identifier at step 608. Additionally, the method 600 includes the RFID tag 604 transmitting the first identifier at step 610. In response to receiving the first identifier, the method 600 includes the host 602 locating a key for the first identifier at step 612. In response to locating the key, the method 600 includes the host 602 requesting a counter value at step 614. The method 600 also includes the RFID tag 604 transmitting the counter value at step 616. Additionally, the method 600 includes the host 602 performing an unauthorized access check at step 618. The method 600 includes the host 602 generating and storing a second identifier at step 620. The method 600 also includes the host 602 transmitting the second identifier at step 622. Additionally, the method 600 includes the RFID tag 604 replacing the first identifier with the second identifier at step 624. The method 600 includes the RFID tag 604 confirming the change of identifiers at step 626.

In various examples, the host 602 includes a controller (e.g., the controller 116, 502) coupled to a storage device (e.g., the storage device 118, the storage device 506) storing machine-readable instructions and a network interface (e.g., the network interface 120, 504). The machine-readable instructions, when executed by the controller, cause the controller to perform portions of the method 600. For example, a machine-readable instruction, when executed by the controller, causes the controller to transmit, via the network interface, the request for the first identifier. In response to receiving, via the network interface, the first identifier, another machine-readable instruction, when executed by the controller, causes the controller to locate the key for the first identifier. The key is stored to the storage device, for example. The controller uses the first identifier to locate the key, for example.

In some examples, in response to locating the key, the controller establishes a secure connection 628 with the RFID tag 604. In some examples, the secure connection 628 uses BLUETOOTH pairing, near-field communication (NFC) pairing, or other suitable wireless communication pairing. In other examples, the secure connection 628 is established using an authenticated encryption technique. The authenticated encryption technique is used in standards or specifications that establish secure communication channels. For example, the secure connection 628 is established using an Advanced Encryption Standard-Galois/Counter Mode (AES-GCM) technique. In some examples, to establish the secure connection 628, the host 602 transmits a first signal to the RFID tag 604. In response to receiving the first signal, the RFID tag 604 locates a key stored to a storage device and generates a key-based response. The RFID tag 604 causes transmission of the key-based response. In response to receiving the key-based response, the host 602 verifies that the key-based response is equivalent to an expected response based on a security key associated with the ID. The secure connection 628 is established in response to a successful verification.

In response to a successful establishment of the secure connection 628, as indicated by the hashed outline, the controller receives the counter value. Using the first identifier, the key, the counter value, or a combination thereof, the controller determines whether the RFID tag 604 has been accessed by an unauthorized party. For example, in response to the counter value not being equivalent to an expected counter value, the controller determines the RFID tag 604 has been accessed by the unauthorized party. The expected counter value is a value stored to the storage device of the host 602, for example. In some examples, the expected counter value is incremented in response to receiving an identifier. In other examples, the expected counter value is incremented in response to a determination that the RFID tag 604 has not had an unauthorized access. In various examples, the expected counter value is incremented in response to confirmation of the ID change. In some examples, the storage device stores a data structure of a set of multiple identifiers (e.g., the multiple identifiers 122, 508) of an RFID tag and an expected counter value associated with each identifier of the set.

In various examples, the expected counter values associated with the set of multiple identifiers includes values that are not immediately sequential in value. For example, a first identifier of the set is associated with an expected counter value of 1, a second identifier of the set is associated with an expected counter value of 2, and a third identifier of the set is associated with an expected counter value of 5. The gap between the expected counter values indicates known instances in which an RFID reader reads the RFID tag 604 but does not transmit the identifier to the host 602. The RFID reader does not transmit the identifier due to a known lack of network access, for example. The expected counter values accounting for a known number of reads that occur when there is a known lack of network access enhances security of the RFID system by reducing an ability of malicious third parties to predict the counter values. As described above with respect to FIG. 1 or 5, for example, the controller generates a notification in response to a determination that the RFID tag 604 has been accessed by the unauthorized party.

In some examples, in response to a determination that the RFID tag 604 has not been accessed by the unauthorized party, the controller generates a second identifier. The controller generates the second identifier using the techniques described above with respect to FIG. 2, for example. The controller stores the second identifier to the storage device and transmits, via the network interface, the second identifier to the RFID tag 604. In various examples, the controller receives, via the network interface, a signal indicating the second identifier has been successfully stored to the RFID tag 604.

In various examples, the RFID tag 604 includes a controller (e.g., the controller 108, 402) coupled to a storage device (e.g., the storage device 110, the storage device 406) storing machine-readable instructions and an antenna (e.g., the antenna 112, 404). The machine-readable instructions, when executed by the controller, cause the controller to perform portions of the method 600. For example, in response to receiving a signal requesting a first identifier, a machine-readable instruction, when executed by the controller, causes the controller to increment a counter value. The counter value is stored to the storage device, for example. Another machine-readable instruction, when executed by the controller, causes the controller to transmit, via the antenna, the first identifier. The first identifier is stored to the storage device, for example. In response to receiving a signal requesting a counter value, a machine-readable instruction, when executed by the controller, causes the controller to transmit, via the antenna, the counter value. In response to receiving, via the antenna, a signal that includes a second identifier, another machine-readable instruction, when executed by the controller, causes the controller to store the second identifier. The controller stores the second identifier to the storage device, for example. In some examples, the controller overwrites the first identifier with the second identifier. Overwriting the first identifier with the second identifier blocks malicious third parties from accessing multiple identifiers of the RFID tag 604 to gain unauthorized access at a later time in a transit process, for example.

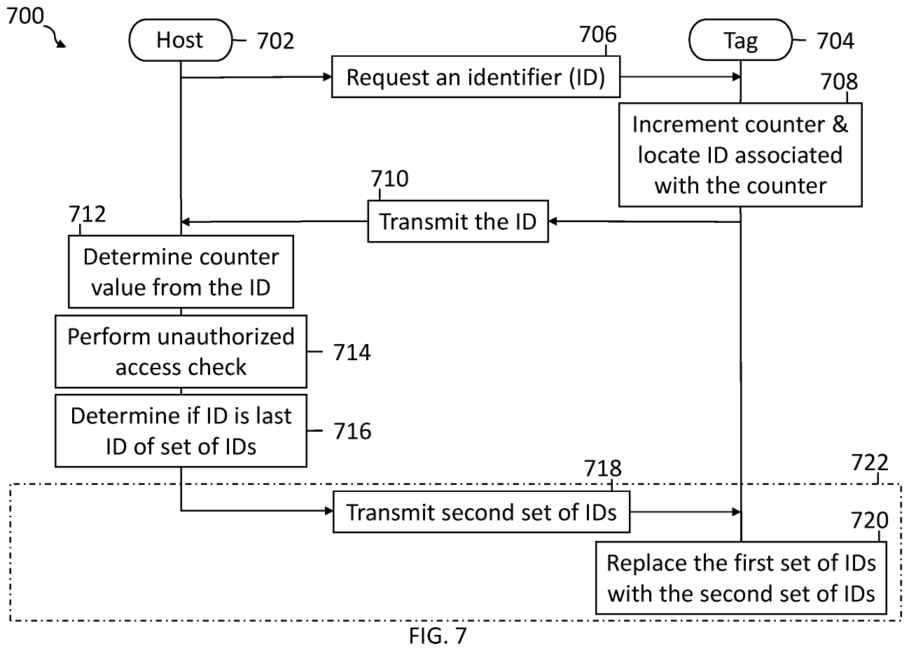

Referring now to FIG. 7, a flow diagram of a method 700 for verifying and provisioning identifiers of RFID tags is shown, in accordance with various examples. A host 702 and an RFID tag 704 perform different portions of the method 700, for example. The host 702 is the electronic device 106, 500, the host 602, for example. The RFID tag 704 is the RFID tag 102, 604, the electronic device 400, for example. The method 700 includes the host 702 requesting an identifier at step 706. In response to receiving the request for the identifier, the method 700 also includes the RFID tag 704 incrementing a counter value and locating an identifier associated with the counter value at step 708. Additionally, the method 700 includes the RFID tag 704 transmitting the identifier associated with the counter value at step 710. In response to receiving the identifier, the method 700 includes the host 702 determining a counter value based on the identifier at step 712. The method 700 also includes the host 702 performing an unauthorized access check at step 714. Additionally, the method 700 includes the host 702 determining whether the identifier is a last identifier of a set of identifiers associated with the RFID tag 704 at step 716. In response to a determination that the identifier is the last identifier, the method 700 includes the host 702 transmitting a second set of identifiers at step 718. The method 700 also includes the RFID tag 704 replacing the first set of identifiers with the second set of identifiers at step 720.

In various examples, the host 702 includes a controller (e.g., the controller 116, 502) coupled to a storage device (e.g., the storage device 118, the storage device 506) storing machine-readable instructions and a network interface (e.g., the network interface 120, 504). The machine-readable instructions, when executed by the controller, cause the controller to perform portions of the method 700. For example, a machine-readable instruction, when executed by the controller, causes the controller to transmit, via the network interface, the request for the identifier. In response to receiving, via the network interface, the identifier, another machine-readable instruction, when executed by the controller, causes the controller to determine the counter value based on the identifier. For example, the controller uses the identifier to locate an expected counter value stored to the storage device, as described above with respect to FIG. 6. In another example, a portion of the identifier includes the counter value. In some examples, a machine-readable instruction, when executed by the controller, causes the controller to locate a key using the identifier. Another machine-readable instruction, when executed by the controller, causes the controller to determine whether the RFID tag 704 has been accessed by an unauthorized party. The controller uses the key to determine whether the RFID tag 704 has been accessed by an unauthorized party, for example. Such determination may include a determination that the unauthorized party has attempted to begin a secure communication session with the RFID tag 704, for example via detecting a session counter mismatch, or a determination that the unauthorized party is attempting to make a copy of the RFID tag 704, for example via detecting an incorrect cryptographic response.

The controller determines whether the RFID tag 704 has been accessed by an unauthorized party using the techniques as described above with respect to FIG. 6, for example. In various examples, in response to a determination that the RFID tag 704 has been accessed by the unauthorized party, the controller generates a notification. In other examples, in response to a determination that the RFID tag 704 has not been accessed by the unauthorized party, another machine-readable instruction, when executed by the controller, causes the controller to determine if the identifier is the last identifier of the set of IDs. In some examples, the controller determines the identifier is the last identifier using the counter value. In other examples, the controller determines the identifier is the last identifier by comparing the identifier to the last identifier of the set of identifiers stored to the storage device.

In some examples, in response to determining that the identifier is the last identifier, the controller generates a second set of identifiers using the techniques described above with respect to FIG. 2. In various examples, the controller establishes a secure connection 722 with the RFID tag 704 using the techniques described above with respect to FIG. 6. In response to a successful establishment of the secure connection 722, as indicated by the hashed outline, the controller transmits, via the network interface, the second set of identifiers. In some examples, the controller transmits a signal to verify receipt of the second set of identifiers. The controller verifies the receipt of the second set of identifiers using the techniques described above with respect to FIG. 6, for example.

In various examples, the RFID tag 704 includes a controller (e.g., the controller 108, 402) coupled to a storage device (e.g., the storage device 110, the storage device 406) storing machine-readable instructions and an antenna (e.g., the antenna 112, 404). The machine-readable instructions, when executed by the controller, cause the controller to perform portions of the method 700. For example, in response to receiving a signal requesting an identifier, a machine-readable instruction, when executed by the controller, causes the controller to increment a counter value. The counter value is stored to the storage device, for example. Another machine-readable instruction, when executed by the controller, causes the controller to locate the identifier associated with the counter value. Another machine-readable instruction, when executed by the controller, causes the controller to transmit, via the antenna, the identifier associated with the counter value. In response to receiving, via the antenna, a signal that includes a second set of identifiers, another machine-readable instruction, when executed by the controller, causes the controller to store the second set of identifiers. The controller stores the second set of identifiers using techniques described above with respect to FIG. 3, for example.

In some examples, instead of replacing the first set of identifiers with the second set of identifiers, the host 702 and the RFID tag 704 return to the first identifier of the first set of identifiers. For example, the controller of the RFID tag 704 resets the counter value to an initial value using the techniques described above with respect to FIG. 3 or 4. In other examples, the RFID tag 704 returns the last identifier for subsequent requests for an identifier. In various examples, the RFID tag 704 continues to increment the counter value, and the host 702 determines whether the RFID tag 704 has been accessed by an unauthorized party using the counter value. In various examples, the host 702 transmits the second set of identifiers in response to an indication from the RFID tag 704 that a transmitted identifier is a last identifier of the first set of identifiers. For example, the RFID tag 704 determines, based on the counter value, that the identifier is the last identifier and transmits the indication.

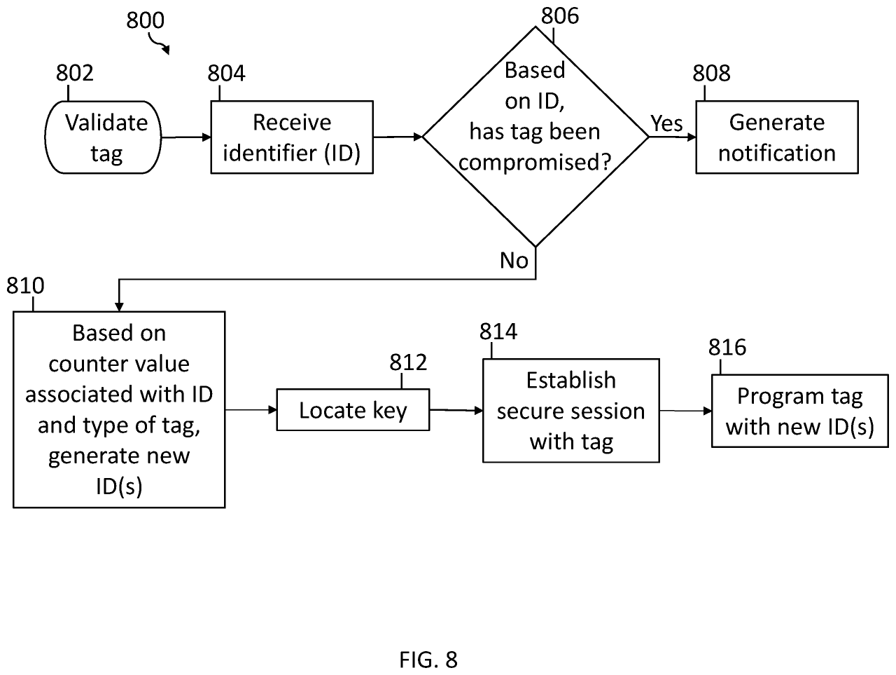

Referring now to FIG. 8, a flow diagram of a method 800 for verifying and provisioning identifiers of RFID tags is shown, in accordance with various examples. The method 800 includes a start point for validating an RFID tag (e.g., the RFID tag 102, 604, 704, the electronic device 400) at step 802. The method 800 also includes receiving an identifier at step 804. Additionally, the method 800 includes determining, based on the identifier, whether the RFID tag has been compromised at step 806. In response to a determination that the RFID tag has been compromised, the method 800 includes generating a notification at step 808.

In response to a determination that the RFID tag has not been compromised, the method 800 also includes generating, based on a counter value associated with the identifier and a type of the RFID tag, a second identifier or a second set of identifiers at step 810. In response to generation of the additional identifiers, the method 800 includes locating a key to establish a secure connection at step 812. The method 800 additionally includes establishing the secure connection (e.g., the secure connection 628, 722) with the RFID tag at step 814. Additionally, the method 800 includes programming the RFID tag with the additional identifiers at step 816.

In various examples, the method 800 is performed by an electronic device (e.g., the electronic device 106, 500, the host 602, 702) of an RFID system (e.g., the system 100). The electronic device includes a controller (e.g., the controller 116, 502) coupled to a storage device (e.g., the storage device 118, the storage device 506) storing machine-readable instructions and a network interface (e.g., the network interface 120, 504). The machine-readable instructions, when executed by the controller, cause the controller to perform portions of the method 800. For example, a machine-readable instruction, when executed by the controller, causes the controller to transmit, via the network interface, the request for the identifier. In response to receiving, via the network interface, the identifier, another machine-readable instruction, when executed by the controller, causes the controller to determine, based on the identifier, whether the RFID tag has been compromised. The controller determines whether the RFID tag has been compromised using the techniques described above with respect to FIG. 6 or 7, for example.

In various examples, in response to a determination that the RFID tag has been compromised, another machine-readable instruction, when executed by the controller, causes the controller to generate the notification. In other examples, in response to a determination that the RFID tag has not been compromised, another machine-readable instruction, when executed by the controller, causes the controller to determine, based on the counter value associated with the identifier and the type of the RFID tag, whether to generate the additional identifiers. In some examples, the controller determines the counter value, the type of the RFID tag, or a combination thereof, based on the identifier. For example, a portion of the identifier includes the counter value, an indicator of the type, or the combination thereof. In another example, the controller uses the identifier to retrieve the counter value, the type, or the combination thereof, from the storage device.

In some examples, in response to determining that the counter value and the type indicate to generate additional identifiers, the controller generates a second identifier or a second set of identifiers using the techniques described above with respect to FIG. 2. In various examples, the controller establishes a secure connection (e.g., the secure connection 628, 722) with the RFID tag using the techniques described above with respect to FIG. 6. In response to a successful establishment of the secure connection, the controller programs, via the network interface, the RFID tag using the techniques described above with respect to FIG. 2, for example.

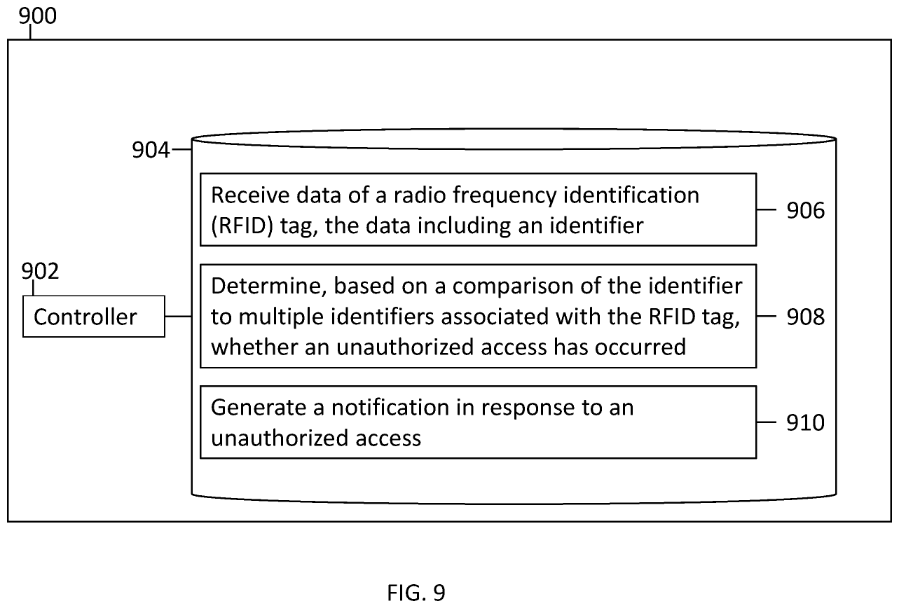

Referring now to FIG. 9, an electronic device 900 for verifying identifiers of RFID tags is shown, in accordance with various examples. The electronic device 900 is the electronic device 106, 500, the host 602, 702, for example. The electronic device 900 includes a controller 902 and a non-transitory machine-readable medium 904. The non-transitory machine-readable medium 904 is the storage device 118, 506, for example.

In some examples, the controller 902 is coupled to the non-transitory machine-readable medium 904. In various examples, the non-transitory machine-readable medium 904 stores machine-readable instructions, which, when executed by the controller 902, cause the controller 902 to perform some or all of the actions attributed herein to the controller 902. The machine-readable instructions are the machine-readable instructions 906, 908, 910.

In various examples, the machine-readable instructions 906, 908, 910, when executed by the controller 902, cause the controller 902 to verify identifiers of RFID tags. A machine-readable instruction 906, when executed by the controller 902, causes the controller 902 to receive data of an RFID tag (e.g., the RFID tag 102, 604, 704, the electronic device 400). The data includes an identifier. A machine-readable instruction 908, when executed by the controller 902, causes the controller 902 to determine, based on a comparison of the identifier to multiple identifiers associated with the RFID tag, whether an unauthorized access has occurred. A machine-readable instruction 910, when executed by the controller 902, causes the controller 902 to generate a notification in response to an unauthorized access.

In some examples, the controller 902 determines whether an unauthorized access of the RFID tag has occurred based on the identifier being different from multiple identifiers associated with the RFID tag. The multiple identifiers are stored to the non-transitory machine-readable medium 904, for example. In other examples, the data includes the identifier, a counter value, a key-based response, or a combination thereof. The controller 902 determines whether the unauthorized access of the RFID tag has occurred based on the identifier being different from multiple identifiers, the key-based response being different from an expected response based on a security key associated with the identifier, the counter value being different than an expected counter value, or a combination thereof. In some examples, the security key, the counter value, or the combination thereof is stored to the non-transitory machine-readable medium 904.

In various examples, the multiple identifiers is a first set of multiple identifiers. In response to a determination that the data indicates an authorized access, the controller 902 determines whether the counter value is equivalent to or greater than a total number of the multiple identifiers. In response to a determination that the counter value is equivalent to or greater than the total number of the multiple identifiers, the controller 902 establishes a secure connection (e.g., the secure connection 628, 722) with the RFID tag. The controller 902 programs a second set of multiple identifiers to the RFID tag.

In various examples, the controller 902 receives second data of a second RFID tag, the data including a key-based response. The controller 902 determines an unauthorized access of the second RFID tag has occurred based on the key-based response not being equivalent to an expected response. In response to a determination that the second data indicates an occurrence of the unauthorized access, the controller 902 generates a second notification. In some examples, the multiple identifiers is a first set of multiple identifiers. In response to a determination that the key-based response indicates an authorized access, the controller 902 establishes a secure connection with the RFID tag. The controller 902 programs the RFID tag with a second set of multiple identifiers.

Unless infeasible, some or all of the method 200, 600, 700, 800 is performed by a controller (e.g., the controller 116, 502, 902) concurrently or in different sequences and by circuitry of an electronic device (e.g., the electronic device 106, 500, 900, the host 602, 702), execution of machine-readable instructions of the electronic device, or a combination thereof. For example, the method 200, 600, 700, 800 is implemented by machine-readable instructions stored to a storage device (e.g., the storage device 118, 506, the non-transitory machine-readable medium 904, or another storage device not explicitly shown of the electronic device), circuitry (some of which is not explicitly shown) of the electronic device, or a combination thereof. The controller executes the machine-readable instructions to perform some or all of the method 200, 600, 700, 800, for example.

In some examples, an RFID reader (e.g., the RFID reader 104) performs some or all of the method 200, 600, 700, 800 concurrently or in different sequences. For example, the RFID includes a controller, a storage device, or a combination thereof. The storage device stores machine-readable instructions that implement the method 200, 600, 700, 800. The controller executes the machine-readable instructions to perform some or all of the method 200, 600, 700, 800, for example. In various examples, the RFID reader transmits the signal that interrogates the RFID tag (e.g., the RFID tag 102, 604, 704, the electronic device 400) and receives the responses from the RFID tag. The RFID reader accesses another electronic device (e.g., the electronic device 106) of the RFID system (e.g., the system 100) to determine whether an ID of the RFID tag is an identifier of multiple identifiers associated with the RFID tag. The another electronic device stores sets of multiple identifiers associated with multiple RFID tags, for example.

Unless infeasible, some or all of the method 300, 600, 700 is performed by a controller (e.g., the controller 108, 402) concurrently or in different sequences and by circuitry of an electronic device (e.g., the RFID tag 102, 604, 704, the electronic device 400), execution of machine-readable instructions of the electronic device, or a combination thereof. For example, the method 300, 600, 700 is implemented by machine-readable instructions stored to a storage device (e.g., the storage device 110, 406, or another storage device not explicitly shown of the electronic device), circuitry (some of which is not explicitly shown) of the electronic device, or a combination thereof. The controller executes the machine-readable instructions to perform some or all of the method 300, 600, 700, for example.

While in various examples described above, an electronic device (e.g., the RFID tag 102, 604, 704, the electronic device 400) is provisioned with multiple identifiers via a programming method (e.g., the method 200, 300, 600, 700, 800), in other examples, the electronic device is provisioned with the multiple identifiers via other programming methods. For example, the electronic device stores the multiple identifiers within memory. The electronic device stores an index of the memory addresses for the multiple identifiers. In response to a counter value, the electronic device accesses the index to locate a memory address storing an identifier of the multiple identifiers. In another example, the electronic device associates multiple flags with the multiple identifiers. A flag of the multiple flags for an identifier of the multiple identifiers indicates whether the identifier has been transmitted. In another example, the electronic device stores an additional bit to a memory address for an identifier. For example, a first bit or a last bit of a memory address is set to a first value to indicate an identifier stored to the memory address has not been transmitted and modified to a second value to indicate the identifier stored to the memory address is transmitted. In some examples, the electronic device is provisioned with a first set of the multiple identifiers at a time of manufacture of the electronic device. For example, the electronic device is provisioned with the multiple identifiers using different manufacturing techniques.

While some components are shown as separate components of the RFID tag 102, the electronic device 106, 400, 500, 900, in other examples, the separate components are integrated in a single package. For example, the storage device 110, 406, is integrated with the controller 108, 402, respectively. The single package may herein be referred to as an integrated circuit (IC) or an integrated chip (IC).

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

What is claimed is:

1. An electronic device, comprising:
a network interface; and
a controller to:
receive, via the network interface, an identifier of a radio frequency identification (RFID) tag; and
generate a notification in response to the identifier being different from a set of identifiers stored to a storage device, the set of identifiers including multiple identifiers associated with the RFID tag.

2. The electronic device of claim 1, wherein the controller is to:
receive, via the network interface, a second identifier of the RFID tag; and
generate a second notification in response to the second identifier being different from the set of identifiers stored to the storage device.

3. The electronic device of claim 1, wherein the controller is to:
receive, via the network interface, a second identifier of a second RFID tag; and
generate a second notification in response to the second identifier being different from a second set of identifiers stored to the storage device, the second set of identifiers including multiple identifiers associated with the second RFID tag.

4. The electronic device of claim 1, wherein the controller is to:
receive, via the network interface, a counter value of the RFID tag;
determine validity of a key based on the counter value and the identifier; and
generate the notification in response to a determination that the key is invalid.

5. The electronic device of claim 4, wherein the controller is to:
generate a second identifier in response to a determination that the key is valid; and
transmit, via the network interface, the second identifier.

6. An electronic device, comprising:
an antenna;
a storage device to store multiple identifiers associated with the electronic device; and
a controller to:
in response to receiving a first radio frequency (RF) signal requesting identification of the electronic device at a first time, transmit, via the antenna, a first identifier of the multiple identifiers; and
in response to receiving a second RF signal requesting the identification at a second time subsequent to the first time, transmit, via the antenna, a second identifier of the multiple identifiers, the second identifier different from the first identifier.

7. The electronic device of claim 6, wherein the controller is to:
in response to receiving the first RF signal requesting identification of the electronic device at the first time, increment a counter value; and
transmit, via the antenna, the first identifier of the multiple identifiers and the counter value.

8. The electronic device of claim 6, wherein the controller is to:
receive, via the antenna, a third RF signal transmitting the second identifier at a third time subsequent to the first time and prior to the second time; and
store, to the storage device, the second identifier.

9. The electronic device of claim 6, wherein the controller is to:
in response to receiving the first RF signal requesting identification of the electronic device at the first time, increment a counter value; and
transmit, via the antenna, the first identifier of the multiple identifiers based on the counter value.

10. The electronic device of claim 6, wherein the multiple identifiers are a first set of identifiers, and wherein the controller is to:
receive, via the antenna, a second set of identifiers; and
store, to the storage device, the second set of identifiers.

11. A non-transitory machine-readable medium storing machine-readable instructions, which, when executed by a controller of an electronic device, cause the controller to:
receive data of a radio frequency identification (RFID) tag, the data including an identifier;
determine whether an unauthorized access of the RFID tag has occurred based on the identifier being different from multiple identifiers associated with the RFID tag; and
in response to a determination that the data indicates an occurrence of the unauthorized access, generate a notification.

12. The non-transitory machine-readable medium of claim 11, wherein the data includes the identifier, a key-based response, a counter value, or a combination thereof; and wherein the controller is to determine whether the unauthorized access of the RFID tag has occurred based on the identifier being different from multiple identifiers, the key-based response being different from an expected response based on a security key associated with the identifier, the counter value being different from an expected counter value, or a combination thereof.

13. The non-transitory machine-readable medium of claim 12, wherein the multiple identifiers is a first set of multiple identifiers, and wherein the machine-readable instructions, when executed by the controller, cause the controller to:
in response to a determination that the data indicates an authorized access, determine whether the counter value is equivalent to or greater than a total number of the multiple identifiers;
in response to a determination that the counter value is equivalent to or greater than the total number of the multiple identifiers, establish a secure connection with the RFID tag; and
program a second set of multiple identifiers to the RFID tag.

14. The non-transitory machine-readable medium of claim 12, wherein the multiple identifiers is a first set of multiple identifiers, and wherein the machine-readable instructions, when executed by the controller, cause the controller to:
in response to a determination that the key-based response indicates an authorized access, establish a secure connection with the RFID tag; and
program a second set of multiple identifiers to the RFID tag.

15. The non-transitory machine-readable medium of claim 11, wherein the machine-readable instructions, when executed by the controller, cause the controller to:
receive second data of a second RFID tag, the data including a key-based response;
determine an unauthorized access of the second RFID tag has occurred based on the key-based response; and
in response to a determination that the second data indicates an occurrence of the unauthorized access, generate a second notification.
